(19) United States
(12) Patent Application Publication
(10) Pub. No.: US 2006/0138787 A1
(43) Pub. Date: Jun. 29, 2006

(54) Hinged lever closing device

(76) Inventor: Dieter Ramsauer, Schwelm (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/545,330

(22) PCT Filed: Nov. 29, 2003
(86) PCT No.: PCT/EP03/13475

§ 371 Date: Aug. 10, 2005

(30) Foreign Application Priority Data
Feb. 10, 2003 (DE) 203 02 151.7

(51) Int. Cl. E05C 3/02

(52) U.S. Cl. 292/194

(57) ABSTRACT

A folding lever closure which can be mounted in a thin wall has a cup-shaped housing whose cup edge terminates in a flange and which can be inserted up to the flange into an elongated opening, such as a rectangular opening, in the thin wall and can be fixed in this position by clamping devices, and within whose longitudinal walls a folding lever is mounted in such a way that it can be folded in, the gripping end of the folding lever being held in the folded in position by a locking lever which can be disengaged and which is arranged in the cup-shaped housing. The other end of the folding lever engages behind a frame part or the like and accordingly presses the thin wall against the frame part. According to the invention, the housing and, optionally, also the folding lever and locking lever, are parts which are injection molded from plastic and have flexible forward projections and/or rearward projections which are formed integral with these parts and which engage in rearward projections and/or forward projections of the other respective part, in which they are supported and/or held, or engage in the back side of the thin wall.

### CROSS-REFERENCE TO RELATED APPLICATIONS

This application claims priority of International Application No. PCT/EP2003/013475, filed Nov. 29, 2003, and German Application No. 203 02 151.7, filed Feb. 10, 2003, the complete disclosures of which are hereby incorporated by reference.

### BACKGROUND OF THE INVENTION

a) Field of the Invention

The invention is directed to a folding lever closure which can be mounted in a thin wall and which has a cup-shaped housing whose cup edge terminates in a flange and which can be inserted up to the flange into an elongated opening, such as a rectangular opening, in the thin wall and can be fixed in this position by means of clamping devices and within whose longitudinal walls a folding lever is mounted in such a way that it can be folded in, the gripping end of the folding lever being held in the folded in position by a locking lever which can be disengaged and which is arranged in the cup-shaped housing, and the other end of the folding lever engages behind a frame or the like.

b) Brief Description of the Related Art

A closure of the type mentioned above is already known from WO 00/73605 A1 in the form of an embodiment example, see FIG. 11 and accompanying description in the above-cited reference.

Further, reference is had in this connection to U.S. Pat. No. 4,693,503. In both cases, the closure is mounted in a rectangular opening arranged in a thin wall in that a bracket is placed on the closure housing from the back and is secured by a screw. The bracket is supported against the rear surface of the wall by its front ends.

A completely different type of closure is described in EP 0 992 644 A2. This closure likewise has a cup-shaped housing whose cup edge terminates in a flange and which is insertable into an elongated opening, such as a rectangular opening, in a thin wall up to the flange. However, instead of using clamping devices that must be screwed on, the closure can be snapped into the opening in that flexible tongues proceed from the cup walls, the end faces of the flexible tongues being supported at the back of the thin wall in the edge area of the opening.

### OBJECT OF THE INVENTION

It is the primary object of the invention to improve a closure of the type mentioned in the beginning in such a way that it can be mounted without special clamping devices that must be screwed on, wherein the simplified mounting extends also to a simplification of the closure itself, i.e., the fewest possible component parts are used and these parts can be assembled with the fewest possible and most uncomplicated assembly steps.

### SUMMARY OF THE INVENTION

This object is met in that the housing, and optionally also the folding lever and locking lever, are parts which are injection molded from plastic and which have flexible forward projections and/or rearward projections which are formed integral with these parts and which engage in rearward projections and/or forward projections of the other respective part, in which they are supported and/or held, or engage in the back side of the thin wall, wherein the locking lever is a lever which is swivelably supported in the housing and from which shaft ends proceed, which shaft ends are inserted into a groove arrangement, one end of the lever forming an operating surface for canceling the locking, while its other end is under spring pressure, and wherein a cylinder lock is accommodated in the operating surface, wherein the locking lever forms a tongue in the vicinity of its shaft ends, which tongue lies behind a projection proceeding from the bottom of the cup-shaped housing when the locking lever is mounted in the cup-shaped housing.

In this way, instead of operating with a clamping screw assembly, a snap-in assembly is used which facilitates mounting of the closure by the end user, but the mounting of the closure itself and its construction are also simplified in that this mounting also makes do with snap-in processes.

In an embodiment form of the invention, as also in EP 0 992 644 A2, protuberances proceed from the outer surface of the housing and contact the back surface of the thin wall in a clamping manner. In particular, two protuberances are provided at the transverse wall or narrow wall of the housing opposite from the folding lever bearing support, which results in a particularly stable bearing support in this area.

However, at least one protuberance which is supported by a tongue formed by wall notches can also proceed from the outer surface of the two longitudinal walls. This is also already known, per se, from EP 0 992 644 A2, but in a different context.

The embodiment forms described up to this point relate to the mounting of the assembled folding lever closure in a thin wall, while the following embodiment forms relate to the assembly of the component parts of the closure to form the finished closure that can be mounted in the thin wall.

A circular projection proceeds from the inner surface of each of the two longitudinal walls, and a recess which forms the folding lever bearing and which has an area that narrows outwardly can be snapped onto the circular projection. This facilitates the insertion of the lever and its mounting inside the cup.

The locking is effected by means of a lever that is swivelably supported in the housing, one end of the lever forming an operating surface for canceling the locking. According to another embodiment form, a groove or slot is provided in the inner surface of each of the two longitudinal walls for receiving a shaft end proceeding from the locking lever. This also facilitates the assembly of the component parts of the closure.

The groove or slot can extend from near the edge of the cup to the bottom of the cup, where it turns toward the narrow end of the cup remote of the folding lever bearing support and terminates in a bearing area with a narrowed location at its entrance. This also serves to facilitate assembly.

In another embodiment form, a flexible tongue is provided in the slot, and the end face of the flexible tongue, together with the end of the slot, forms a bearing support of the shaft end. This is another embodiment form of the snap-type mounting of the lever in the cup-shaped housing.

A spring is advantageously provided to enable automatic folding of the folding lever closure. In this case, it is advantageous when a receptacle for a leaf spring or for a wire spring is provided in the locking lever end remote of the operating surface, the other end of the leaf spring or wire spring being supported in the folding lever.

The receptacle can comprise a hook device for pre-setting the spring, which again facilitates mounting of the component parts of the closure in the factory.

### BRIEF DESCRIPTION OF THE DRAWINGS

In the drawings:

The invention will be explained more fully with reference to embodiment examples shown in the drawings.

FIG. 1A is a side view of a first embodiment form of a folding lever closure, according to the invention, which is mounted in a sheet-metal cabinet door;

FIG. 1B is a top view of the folding lever closure according to FIG. 1A;

FIG. 1C is an opposite view of the folding lever closure according to FIG. 1A;

FIG. 1D is an axial, sectional view of the folding lever closure according to FIG. 1A;

FIG. 1E is a front view from the left-hand side referring to FIG. 1B;

FIG. 1F is a perspective view of the underside of the folding lever closure according to the invention;

FIG. 1G is a corresponding perspective view of the upper side of the folding lever;

FIG. 2 is a view of a suitable rectangular opening in a door leaf of sheet metal or other thin wall for the folding lever shown in FIGS. 1A to 1G;

FIGS. 3A to 3F show different views of the cup-shaped housing of the folding lever closure shown in FIGS. 1A to 1G;

FIGS. 4A to 4E show different views of the folding lever of the folding lever closure shown in FIGS. 1A to 1G;

FIGS. 5A to 5G show different views of the locking lever of the folding lever closure shown in FIGS. 1A to 1G;

FIG. 6 shows a perspective, exploded view, in partial section, of the essential structural component parts of the folding lever closure shown in FIGS. 1A to 1G;

FIG. 7 is a perspective view of the parts shown in FIG. 6 after assembly; and

FIG. 8 is a perspective view of an alternative form of the cup-shaped housing.

### DESCRIPTION OF THE PREFERRED EMBODIMENTS

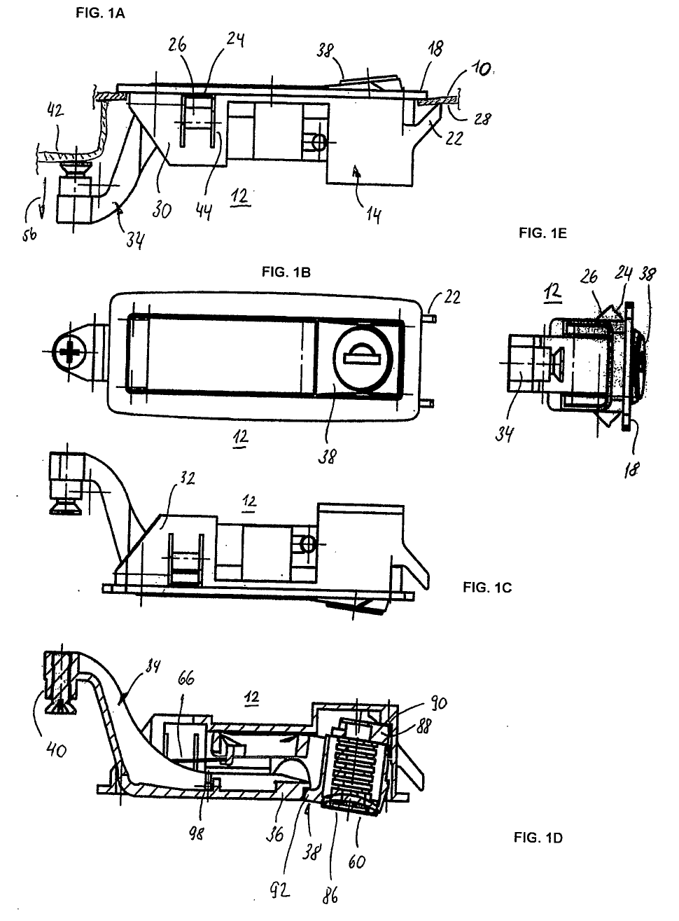

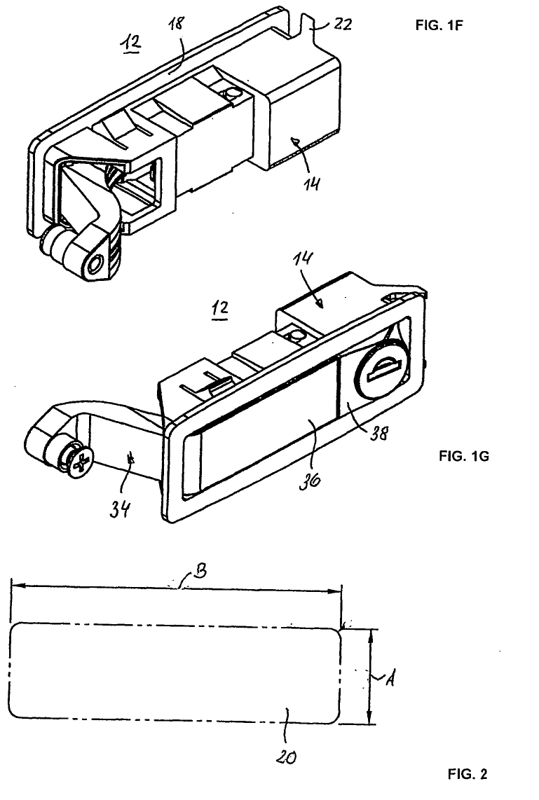

FIG. 1A shows a side view of a folding lever closure 12 which is mounted in a thin wall such as a door leaf 10 and which, as will be described in detail, comprises a cup-shaped housing 14 whose cup edge terminates in a flange 18, and which housing can be inserted up to the flange 18 into an elongated, e.g., rectangular, opening 20 (see FIG. 2) in a thin wall 10 and can be fixed in this position by means of clamping devices such as, in this case, protuberances 22 proceeding from the outer surface of the housing 14 and end faces 24 of tongues 26 which contact the back surface 28 of the thin wall 10. A folding lever 34 is mounted between the longitudinal walls 30, 32 of the cup-shaped housing 14 in such a way that it can be folded in, its operating end or gripping end 36 being held in the folded in position (see FIG. 1D) by a locking lever 38 which can be disengaged and which is arranged in the cup, while the other end 40 engages behind a bevel area of a frame 42 or the like.

The housing 14 and, optionally, also the folding lever 34 and locking lever 38 are parts that are injection molded from plastic and these parts are outfitted in each instance with flexible forward projections and/or rearward projections that are formed integral with these parts. For example, the housing 14 is outfitted with the protuberances 22 and tongues 26, mentioned above, which engage in rearward projections and/or forward projections of the other respective part in which they are supported and/or held. With respect to the housing 14, protuberances 22 and tongues 26, respectively, engage in the back surface 28 of the thin wall 10 as can be seen in FIG. 1A.

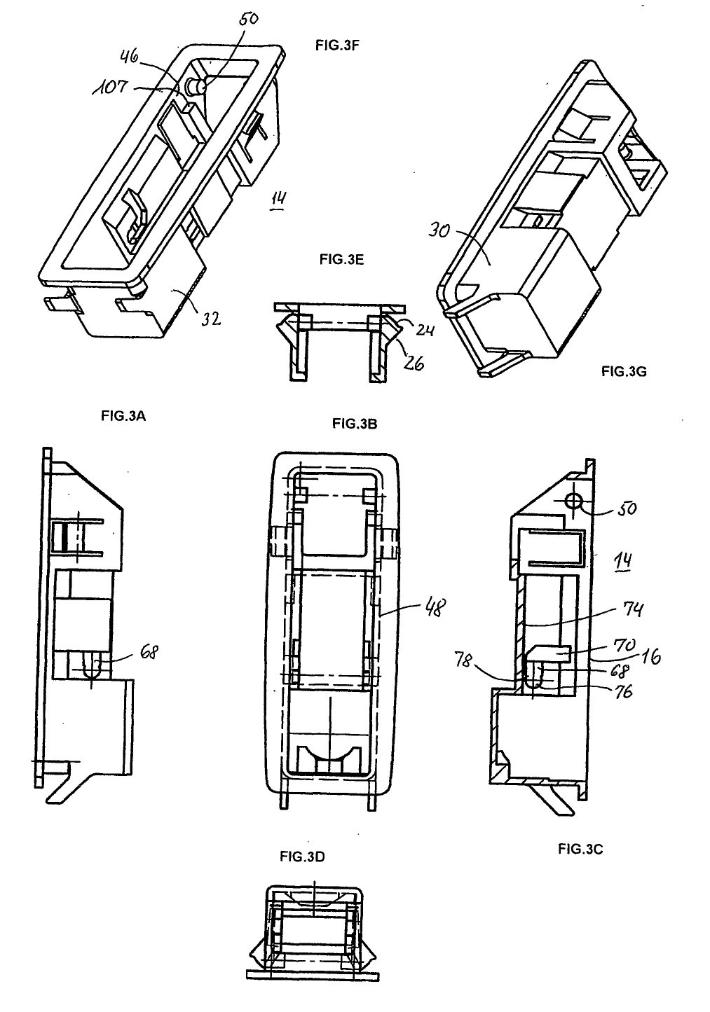

The tongues 26 are formed in that wall notches 44 are formed by the outer surface of the two longitudinal walls 30, 32. The shape of the protuberance 22 is selected in such a way that, in a manner similar to that shown in EP 0992644 with reference to FIG. 1A, with the housing initially held diagonally with respect to the thin wall, this housing is placed on one narrow end A of the opening 20 in the thin wall 10, whereupon the opposite portion of the housing is swiveled toward the thin wall until the broad sides B of the wall opening encounter the flange 18 while allowing the end faces of the tongues 26 to pass as the latter are pushed back. The tongues 26 then spring back so that the housing 14 is locked in the opening 20. The slanting of the end faces 24 of the tongue 26 which is shown in FIG. 3E makes it possible to adapt to different wall thicknesses of the thin wall 10.

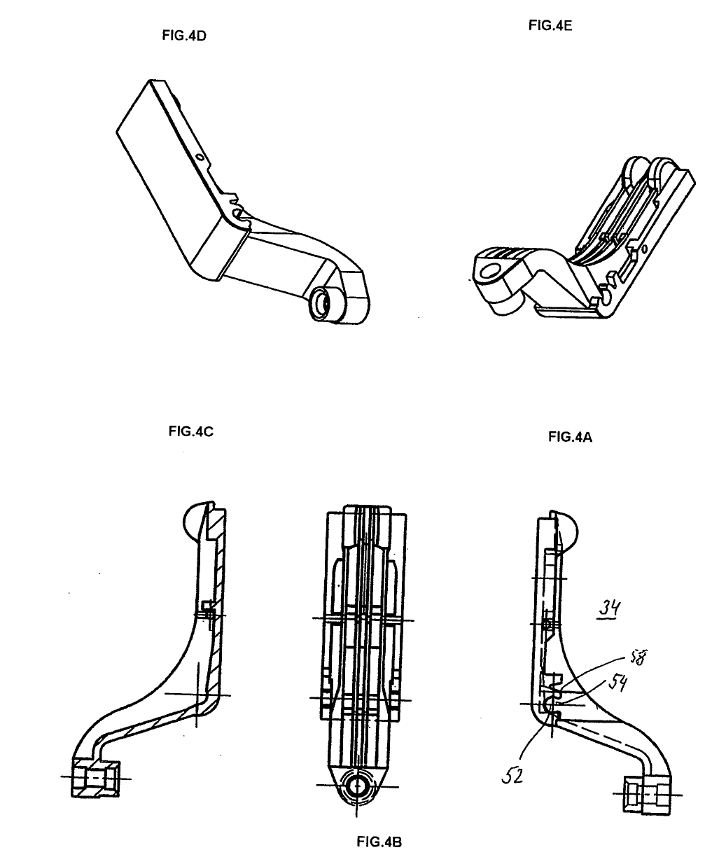

A circular projection 50 proceeds from the inner surface 46 of each of the two longitudinal walls 30, 32 of the housing 14. A recess 52 which forms the bearing of the folding lever 34 and which has an area 54 that is narrower on the outer side can be clipped onto this circular projection 50 (see the perspective view of the housing 14 in FIG. 5F and the side view of the folding lever 34 in FIG. 4F).

The narrowed area 54 prevents the folding lever from exiting the bearing support again in an unintentional manner.

The forces exerted on the folding lever 34 during operation (see arrow 56 in FIG. 1A) tend to press the projection 50 serving as bearing shaft end into the closed end of the bearing 52, which also ensures that the folding lever remains in its working position.

On the other hand, the opening leading to the recess 52 is somewhat funnel-shaped as can be seen in FIG. 4A, and one funnel wall is made flexible by means of a notch 58 arranged behind it to the extent that no problems are caused when the shaft end 50 proceeding from the housing 14 is inserted into the recess 52.

The locking lever 38 shown in FIG. 1D comprises a lever that is swivelably supported in the housing 14. One end of the lever forms or carries an operating surface 60 which can be pressed by a finger so as to disengage the lock and the other end 64 is under pressure by a spring 66 which tends to press the locking lever 38 into its locking position.

In order to mount this locking lever 38 in a swivelable manner, a groove or a slot 68, 70 which can receive a shaft end 72 proceeding from the locking lever 38 is provided, respectively, in the inner surface of the two longitudinal walls 30, 32 referring to FIGS. 1A to 7. The slot 68 is so shaped only because this can be carried out more easily by injection molding technique and would also work as a groove shape. The groove 70 or the slot 68 starts at the edge of the cup and extends first in direction of the bottom 74 of the cup, then turns toward the narrow end 62 of the cup-shaped housing 14 remote of the folding lever bearing 50, runs substantially parallel to the cup bottom, and ends in a bearing area 76 at whose entrance a narrowed location 78 is arranged, again so as to ensure a snap-type fastening.

In the alternative embodiment form of a cup-shaped housing 114 shown in FIG. 8, a flexible tongue 80 is arranged in the slot 170 and, together with the slot end 84, its end face 82 forms a bearing for the shaft end of the locking lever 38.

As is shown in FIGS. 1A to 1G, a cylinder lock 86 can be arranged in the locking lever 38 and its end face having the keyhole could form the operating surface.

In the closed position, the cam 88 of this cylinder lock 86 lies against a shoulder 90 formed by the housing 14 and accordingly prevents the locking lever 38 from being pressed down and actuated, so that a protuberance 92 that is formed by the operating surface 60 secures the folding lever 34 in the folded in position shown in FIG. 1D.

On the other hand, when the cylinder 86 is actuated until the cam 88 is released, the lever 38 can be pressed down at a determined angle and the protuberance 92 releases the lever 36 so that the lever 36 is folded up due to the force of the spring 66 and in turn releases the frame 42 so that the door or the like (see reference number 10) can be swiveled away from the frame 42.

A receptacle 94 for one end of a leaf spring or wire spring 66 is provided in the end of the locking lever 38 remote of the operating surface, the other end 96 of the leaf spring or wire spring 66 being mounted with its angled portions in corresponding openings 98 of the folding lever 34.

Again in order to facilitate the assembly of the parts of the closure, the lever 38 comprises a hook device 100 at 94 for pre-setting the spring 66 in the locking lever 38.

To adjust the stiffness of the closure, the folding lever 34 can also comprise an adjusting screw 102 which can be screwed into and out of a thread 104 formed in the lever end until the desired stiffness is achieved between the door leaf 10 and the door frame 43.

As can be seen in the perspective view of the overall arrangement in FIG. 7, the housing bottom 74 can also have a projection 105 behind which a tongue 106 proceeding from the locking lever 38 can lock so as to further facilitate assembly. In this way, the underside of the tongue 106 lies on the projection 105 when the locking lever 38 is inserted, so that the tongue snaps behind the projection 105 (FIG. 7) when the lever 38 is subsequently displaced in the longitudinal direction of the housing.

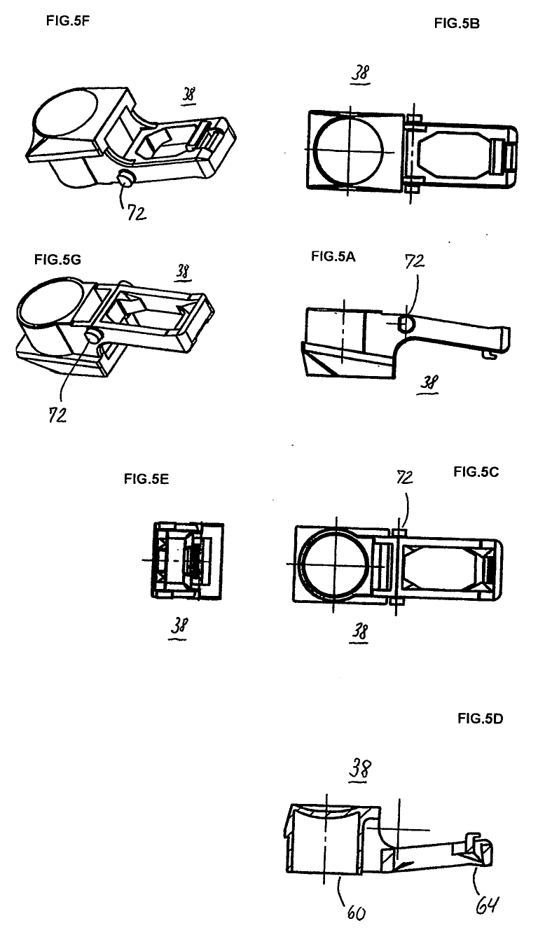

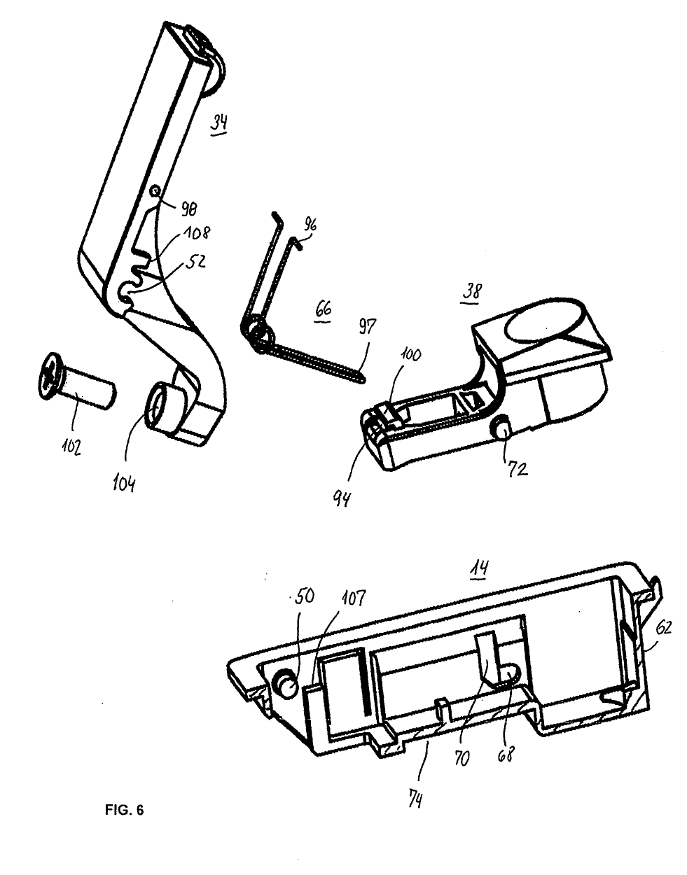

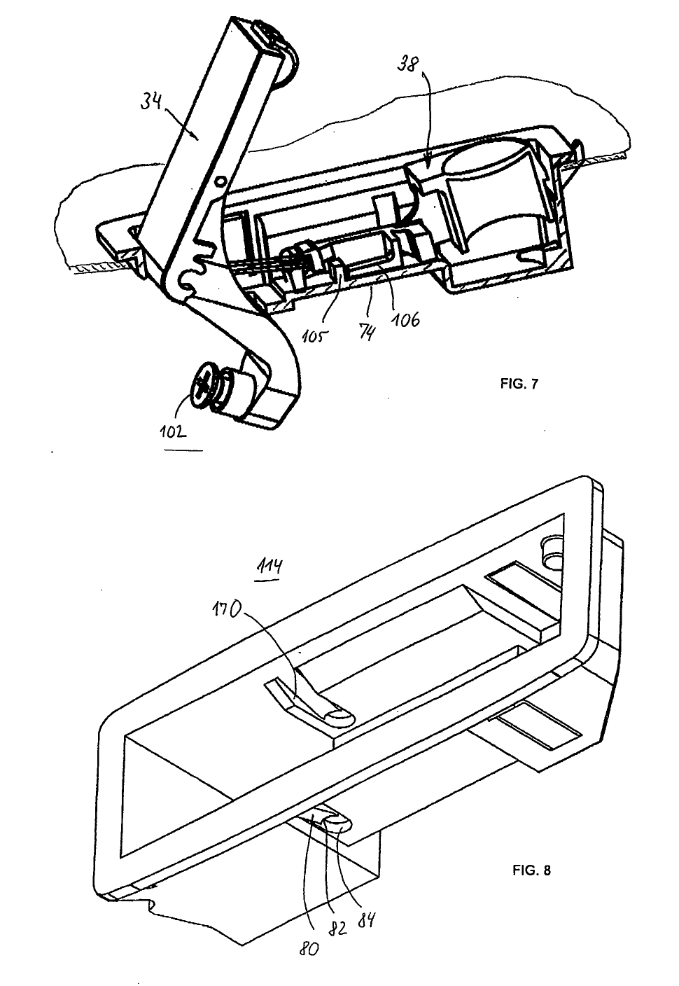

Accordingly, the assembly process is as follows: First, referring to FIG. 6, the end 97 of the spring 66 is hooked into the hook device 100 of the locking lever 62 and pre-set for the assembly of the locking lever. Then the other end 96 of the spring 66 can be hooked into the bore holes 98 of the folding lever 34 from the inside by the portions that are bent outward by pressing these portions together. The bearing pin 72 can now be inserted into the groove arrangement 70 and displaced in direction of the bottom 74 of the housing 14. As was already described, the tongue 106 of the locking lever 38 now lies on the rear-locking projection 105. When the bearing pin 72 is subsequently displaced parallel to the bottom surface 74 of the housing 14 in the direction of the groove arrangement or slot arrangement 68, the tongue 106 locks behind the projection 105 and secures the arrangement of the locking lever 38 in the housing 14. The folding lever 34 can now be placed on the bearing pin 50 by its bearing opening 52 accompanied by tensioning of the spring 66. It should also be noted that a supporting surface 107 cooperates with a supporting surface 108 of the folding lever 34 to further facilitate assembly. Further, this supporting surface 107 relieves the end 50 from the pressing force of the door leaf 10 against the door frame 42 that must be absorbed by the folding lever 34.

### COMMERCIAL APPLICABILITY

The invention is commercially applicable in switch cabinet construction.

While the foregoing description and drawings represent the present invention, it will be obvious to those skilled in the art that various changes may be made therein without departing from the true spirit and scope of the present invention.

What is claimed is:

1-11. (canceled)

12. A folding lever closure which can be mounted in a thin wall and which comprises:
a cup-shaped housing whose cup edge terminates in a flange and which can be inserted up to the flange into an elongated opening, such as a rectangular opening, in the thin wall and can be fixed in this position by clamping devices;
a folding lever being mounted within longitudinal walls of said housing in such a way that it can be folded in, a gripping end of the folding lever being held in the folded in position by a locking lever which can be disengaged and which is arranged in the cup-shaped housing;
said folding lever having another end which engages behind a frame or the like;
said housing and, optionally, also the folding lever and locking lever being injection-molded parts of plastic, such as polyamide, and have flexible forward projections and/or rearward projections which are formed integral with these parts and which engage in rearward projections and/or forward projections of the other respective part, in which they are supported and/or held, or engage in the back side of the thin wall;
said locking lever being a lever which is swivelably supported in the housing and from which shaft ends proceed;
said shaft ends being inserted into a groove arrangement of the housing;
one end of the lever forming an operating surface for canceling the locking, while another end is under spring pressure; and
a cylinder lock being accommodated in the operating surface;
said locking lever forming a tongue in the vicinity of its shaft ends, said tongue lying behind a projection proceeding from a bottom of the cup-shaped housing when the locking lever is mounted in the cup-shaped housing.

13. The folding lever closure according to claim 12, wherein a groove or slot is provided, respectively, in the inner surface of the two longitudinal walls, for receiving a shaft end proceeding from the locking lever.

14. The folding lever closure according to claim 13, wherein the groove or the slot extends from near the edge of the cup to the bottom of the cup, turns toward the narrow wall of the cup-shaped housing remote of the folding lever bearing support, and terminates in a bearing area with a narrowed location at its entrance.

15. The folding lever closure according to claim 13, wherein a flexible tongue extends into the slot, and the end face of the flexible tongue, together with the end of the slot, forms a bearing support for the shaft end.

16. The folding lever closure according to claim 12, wherein a receptacle for a leaf spring or for a wire spring is provided in the end of the locking lever remote of the operating surface, the other end of the leaf spring or wire spring being supported in the folding lever.

17. The folding lever closure according to claim 16, wherein the receptacle comprises a hook device for pre-setting the spring.

18. The folding lever closure according to claim 12, wherein protuberances proceed from the outer surface of the housing and contact the back side of the thin wall in a clamping manner.

19. The folding lever closure according to claim 18, wherein two protuberances proceed from the narrow wall (transverse wall) of the housing located opposite to the folding lever arrangement.

20. The folding lever closure according to claim 18, wherein at least one protuberance which is carried by a tongue formed by wall notches proceeds from the outer surface of the two longitudinal walls.

21. The folding lever closure according to claim 12, wherein a circular projection proceeds from the inner surface, respectively, of the two longitudinal walls, and a recess which forms the bearing for the folding lever and which has an area that narrows on the outer side can be clipped onto the circular projection.

22. The folding lever closure according to claim 12, wherein a support for additionally supporting the folding lever when the folding lever is in the swiveled in position is provided by the inner surface of the two longitudinal walls near the circular projection.
